(19) United States
(12) Patent Application Publication
(10) Pub. No.: US 2010/0246085 A1
(43) Pub. Date: Sep. 30, 2010

(54) HIGH-VOLTAGE DEVICE

(75) Inventors: Walter HOLAUS, Zurich (CH); Jasmin Smajic, Schoefflisdorf (CH); Jadran Kostovic, Wettingen (CH)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/732,789

(22) Filed: Mar. 26, 2010

(30) Foreign Application Priority Data
Mar. 27, 2009 (EP) 09156418.7

(51) Int. Cl. H02H 3/22

(52) U.S. Cl. 361/111

(57) ABSTRACT

A high-voltage device includes a conducting element for conducting a high-voltage current and at least one transient reducing unit for reducing voltage peaks of existing propagating very fast transients (VFTs) by the generation of arcing. The transient reducing unit has at least one arcing occurrence surface. The at least one arcing occurrence surface of the at least one transient reducing unit is positioned in the vicinity of the conducting element such that arcing occurs between the transient reducing unit and the conducting element when the potential difference between the transient reducing unit and the transient conducting element is above a threshold value, such as at the occurrence of a very fast transient. A method is also provided for equipping a high-voltage device with the transient reducing unit.

### RELATED APPLICATION

This application claims priority under 35 U.S.C. §119 to European Patent Application No. 09156418.7 filed in Europe on Mar. 27, 2009, the entire content of which is hereby incorporated by reference in its entirety.

### FIELD

The present disclosure generally relates to a high-voltage device and method for equipping a high-voltage device with means for reducing very fast transients (VFTs). More particularly, the present disclosure relates to a high-voltage switching or conducting device having means for reducing VFTs and a method for equipping a switching or conducting device with means for reducing VFTs.

### BACKGROUND INFORMATION

Switching operations with disconnectors in a high-voltage gas-insulated switchgear generate VFTs that propagate through the gas insulated switchgear (GIS) as travelling waves. Depending on the switching case and due to reflection and superposition, the peak values of the VFT can reach values up to the basic insulation level (BIL) of the GIS. Specifically, the high rate-of-rise of VFT (e.g. about 200 kV within 10 ns) can lead to failures in equipment which is directly connected to the GIS as high-voltage transformers, for example.

There is therefore a desire to avoid the generation of very high VFTs or to apply solutions that result in the generation of reduced VFTs that are as small as possible.

In order to do so, disconnectors at ultra-high voltage (UHV) levels (e.g. above about 550 kV) are commonly equipped with VFT damping resistors of several 100Ω up to 1 kΩ. Parallel to the main contact of a disconnector, a further contact is provided on which a resistor is positioned. The contact is provided with a gap so that the current flows through arcing. The arrangement is such that, when the disconnector is closed, first the contact along the path comprising the resistor is engaged. The current flowing through the disconnector is therefore reduced in comparison to the situation when the disconnector is totally closed. Hence, by providing these two circuits, the sudden rise of current through the disconnector can be softened. This results in the generation of a reduced VFT.

However, these resistors are typically placed in the contact system of the disconnectors. They therefore strongly increase the size and complexity of the disconnector. Further, they do not contribute to reducing existing VFTs but aim only at generating smaller VFTs during switching.

Further, In GIS designs, contacts in the active parts such as plug contacts in busbars or contacts of a switchgear such as disconnectors are shielded by metallic shields. These shields aim at providing a good dielectric design. They are arranged in such a way that there is no current flowing through them and no active interaction such as arcing with any conducting element.

### SUMMARY

An exemplary embodiment provides a high-voltage device. The exemplary high-voltage device comprises a conducting element for conducting a high-voltage current. The exemplary high-voltage device also comprises at least one transient reducing unit for reducing voltage peaks of existing propagating very fast transients by the generation of arcing. The at least one transient reducing unit has at least one arcing occurrence surface and at least one permanent electric contact portion being conductively connected to the conducting element. The at least one arcing occurrence surface of the at least one transient reducing unit is positioned in a vicinity of the conducting element to enable arcing to occur in a gap located between the at least one transient reducing unit and the conducting element when a transient potential difference between the at least one transient reducing unit and the conducting element is above a threshold value.

An exemplary embodiment provides a method for enabling a high-voltage device to reduce very fast transients. The high-voltage device has a conducting element and is adapted for at least one of conducting and switching high currents. The exemplary method comprising positioning at least one transient reducing unit for reducing voltage peaks of existing propagating very fast transients in a direct vicinity of a conducting element to generate arcing between the conducting element and at least one arcing occurrence surface of the at least one transient reducing unit when a transient potential difference between the at least one transient reducing unit and the conducting element is above a threshold value. The at least one arcing occurrence surface is arranged at an opposite end of at least one permanent electric contact portion of the at least one transient reducing unit that is conductively connected to the conducting element.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a cross sectional view of a section through a high-voltage device according to an exemplary embodiment of the present disclosure;

FIG. 2 shows a detailed illustration of an arcing region marked out in FIG. 1;

FIG. 3 shows a cross-sectional illustration of an exemplary transient reducing unit in the detail view as shown in FIG. 2;

FIG. 4 shows a cross-sectional illustration of an exemplary transient reducing unit in the detail view as shown in FIG. 2;

FIG. 5 is a three-dimensional illustration of a conductor being surrounded by a plate-shaped transient reducing unit according to an exemplary embodiment;

FIG. 6 is a cross-sectional illustration of a housed conductor being provided with transient reducing units according to exemplary embodiments of the present disclosure;

FIG. 7 is a schematic three-dimensional illustration of an open wire being provided with transient reducing units according to exemplary embodiments of the present disclosure;

FIG. 8 is another schematic three-dimensional illustration of an exemplary transient reducing unit connected on a conductor, wherein the arcing occurrence surface features a small protrusion for defining the exact spot where arcing is triggered;

FIG. 9 is a schematic three-dimensional illustration of an exemplary transient reducing unit connected on a conductor, wherein the transient reducing unit is rotationally asymmetric with reference to the longitudinal axis;

FIG. 10 is a schematic two-dimensional illustration of an exemplary transient reducing unit similar to the one shown in FIG. 2;

FIG. 11 is a schematic two-dimensional illustration of an exemplary transient reducing unit whose interior volume is increased by a recess that is engirding the conductor; and

FIG. 12 shows measurement results of VFTs in a high current device comprising a transient reducing unit according to exemplary embodiments of the present disclosure in comparison to a high voltage conducting device not having a transient reducing unit.

### DETAILED DESCRIPTION

In view of the above, a high-voltage device is provided that includes a conducting element for conducting high-voltage current and at least one transient reducing unit for reducing voltage peaks of propagating VFTs that are propagating in the direction of the conducting element by the generation of arcing. The transient reducing unit has at least one arcing occurrence surface and at least one permanent electric contact portion that is conductively connected to the conducting element. The at least one arcing occurrence surface of the at least one transient reducing unit is positioned in the direct vicinity of the conducting element such that intentional arcing occurs at VFT stress between the transient reducing unit and the conducting element when the transient potential difference between the transient reducing unit and the conducting element is above a threshold value.

The threshold value depends on the kind of VFTs to be reduced and on the strength of the electric field generated in between the transient reducing unit and the conducting element, which electric field is required for the arcing process. Thus, an inventive embodiment according to the present disclosure comprises several transient reducing units, whereof at least two transient reducing units differ to one another in their geometry and/or size. The geometry and/or the choice of material for the transient reducing units or for parts/portions thereof is selectable in order to customize the desired different behaviour of the different transient reducing units in relation to the VFTs to be reduced. Such an embodiment contributes to successfully reducing a variety of different VFTs.

Depending on the envisaged VFTs and/or other particularities, the threshold value is in a range of about 5 kV to about 100 kV, for example, in a range of about 10 kV to about 80 kV.

The transient reducing unit confers the conducting element with a locally distinct geometry. The transient reducing unit is shaped and dimensioned such that the waveguide propagation of at least one VFT-wave along the conducting element is affected, e.g. in that a VFT wave is dampened, i.e. reduced, or blocked. This damping effect is achieved by a local intentional arc discharge between the at least one arcing occurrence surface and a most proximate portion of the conducting element in its vicinity, since the arcing consumes a portion of the energy of the VFT leading to a smoothened overall voltage course.

At the time the very fast transient wave, which is to be understood as a non-harmonic impulse rather than a single mono-frequent wave, passes the permanent electric contact portion of the transient reducing unit, a change in the waveguide impedance is caused by the locally distinct geometry provided by the transient reducing unit. The locally distinct geometry modifies the wave propagation in that a portion of the VFT wave is branched off the conducting element and led into the conducting body of the transient reducing unit. In case that the VFT wave passes the permanent electric contact portion first and the arcing occurrence surface thereafter, the VFT wave propagates further along the conducting element quickly and leaves the area of the transient reducing unit before the branched-off portion of the VFT wave reaches the arcing occurrence surface. This time offset/delay leads to distinctively different electric potentials of the conducting element and the conducting body of the transient reducing unit along the area where the transient reducing unit is arranged for a very short moment in time (typically within a few nanoseconds). Expressed differently, arcing is caused for a particular VFT because of a transient potential difference at a given moment in time at the gap located in between the conducting element and the arcing occurrence surface of the transient reducing unit. The transient potential difference is also referred to as U_{diff} hereinafter. These different electric potentials, i.e. U_{diff}, cause an electric field between the transient reducing unit and the conducting element. As indicated above, the electric field is reduced subsequently by the arc discharge. The efficiency of the VFT damping depends mainly on the impulse steepness of the VFT and its maximum value. The higher U_{diff} is, the more intense electric arcing at the gap occurs and thus the better the VFT damping is.

An electric field is also created in case that the VFT wave passes the arcing occurrence surface first and the permanent electric contact portion thereafter, since the electric potentials in the conducting element and the conducting body of the transient reducing unit are also different from one another for a very short moment in time. Hence, arcing will also take place if the VFT is propagating in the opposite direction in the conducting element than described above.

The geometry of the transient reducing unit defines the strength of the electric field and depends on parameters like the frequency or the frequency range of the VFT waves to be reduced, and the choice of the gaseous insulating means present at the gap in between the arcing occurrence surface and the conducting element in terms of its dielectric value such that arcing occurs.

The at least one arcing occurrence surface and the at least one permanent electric contact portion where the transient reducing unit is conductively connected to the conducting element are displaced from one another by a distance which is shorter than the wavelength of the VFT wave to be dampened. This distance extends in the direction of the VFT wave propagation, i.e. in the direction of a longitudinal axis defined by the conducting element. This axial displacement forms a parameter for the electric field to be generated.

Thus, the axial displacement as well as the size of the gap between the arcing occurrence surface and the conducting element form determinative parameters of the geometry of the transient reducing units. Additional determinative parameters can be the shape of the gap in between the arcing occurrence surface and the conducting element, as well as the size of an interior volume of the transient reducing unit. The volume is mainly delimited by the body of the shell-like intermediate portion of the transient reducing unit and the conductor element itself and open at the gap in between the arcing occurrence surface and the conducting element. In a GIS environment, the interior volume contains an insulation gas that is allowed to circulate in and out of the interior volume through the gap.

The interior volume as well as the gap geometry are effective for defining the resonance frequency fᵣₑₛ of a transient reducing unit such that the energy of a VFT can be eliminated optimally. The following law applies for the resonance frequency fᵣₑₛ of the resonator, where L is the equivalent lumped inductance and C the equivalent lumped capacitance of the unit.:

$${f}_{res} = \frac{1}{2 Π \times \sqrt{L \times C }}$$

Hereinafter, the term gap geometry is understood as the size and the shape of the gap formed in between the arcing occurrence surface and the surface of the conducting element.

In terms of damping of a VFT, it is advantageous to have a resonance frequency in the lower portion of the VFT frequency range where the most dominant components of the VFT are located.

The equivalent lumped capacitance of the transient damping unit can be determined by the size and shape of the arcing gap, as the electric field of the unit is confined in the narrow gap volume. Simulations and tests revealed that the damping efficiency rises the longer and smaller the gap in between the arcing occurrence surface and the conducting element is. This is easy to understand as a longer and smaller gap makes the corresponding capacitance higher and resonance frequency lower.

Advantageous damping results are achievable, if the gap has a tunnel-like gap geometry with a gap length extending in a longitudinal direction defined by a longitudinal axis of the conducting element, wherein the gap length measures at least as much as the gap distance in between the arcing occurrence surface and said conducting element. In other words, the arcing occurrence surface of the transient reducing unit has a planar extension with respect to the surface of the conducting element such that a condenser is formed.

The equivalent lumped inductance of the damping unit is determined by the size of the interior volume. This is also easy to understand as the magnetic field of the unit is distributed over its volume (simulations show that the magnetic field is not so highly confined in the gap as the electric field but rather smoothly distributed over the transient reducing unit's interior volume). Thus, the larger the interior volume gets the higher inductance and lower resonance frequency is obtainable. As explained before, lower resonance frequency yield more efficient damping.

Increasing the interior volume can be achieved by either increasing an outer diameter of the transient reducing unit, e.g. at the intermediate portion, and/or by reducing the diameter of the conductor element at the place of the transient reducing unit. The technical effect of an increased outer diameter of the transient reducing unit for a given VFT is twofold. First, it creates a longer current path length a VFT wave has to travel along within the transient reducing unit before reaching the arcing occurrence surface. The longer current path length is responsible for an increased time offset of the amplitude of the VFT wave at the gap in the conducting element, e.g. the conductor bar, and the arcing occurrence surface of the transient reducing unit at a given moment in time. The larger the time offset is, the larger the time shift voltage U_{Δt} contributing to a larger transient potential difference U_{diff} will be, and thus to a more intense electric arcing at the gap that is advantageous for VFT damping. Second, increasing the outer diameter of the transient reducing unit for a given VFT leads to an increased interior volume and as a consequence thereof to an increased inductance of the resonator, lower resonance frequency and therefore higher transient potential difference U_{diff}.

Since the limits for the outer diameter may be effected by the dielectric stress between the conductor element and its enclosure by a corresponding transient reducing element, the VFT damping effect can be further improved by increasing the interior diameter without increasing the outer diameter of the transient reducing unit any further but by reducing an inner dimension of the conducting element proximate to the interior volume of the transient reducing unit locally by means of a recess. Depending on the embodiment of the transient reducing unit, the latter is preferably of shell-like type. For instance, a shell plate may be arranged partly or completely around the conducting element in a predetermined distance such that it is encompassing and covering a longitudinal portion of the conducting element. For example, the recess can be formed by a circumferentially extending diminution, e.g. a neck portion, with a locally reduced diameter or a pocket. The limits for the reduced diameter causing the recess are given by the minimum conductor element cross section required by the current carrying capability. The recess leads to a local extension of the current path for VFTs that extends along the surface of the conductor element owing to the applying skin effect and thus affects time shift voltage U_{Δt}. Although the recess may lead to a decreased share of the time shift voltage U_{Δt} on the transient potential difference U_{diff}, the increased interior volume contributes to an increased share of the resonant voltage portion U_{RES} on the transient potential difference U_{diff}. Tests revealed that the resonant voltage portion U_{RES} share is at least as large as the time shift voltage U_{Δt}, if not larger such that it outweighs its drawback on the time shift voltage U_{Δt} typically by far. The damping efficiency rises the larger the interior volume size is.

In an exemplary embodiment of the transient reducing unit, the pocket may only partly encompass the conductor element in the circumferential direction leading to an asymmetric conductor element design when seen in the cross-section.

Since both the equivalent lumped capacitance and inductance of the damping unit are parameters independent from one another to a large extent, they are subject to optimizations according to their requirements and specifics. However, a particularly satisfying damping efficiency for particular VFTs is achievable where both the interior volume and the gap geometry are optimized leading to a large resonant voltage share of the transient potential difference.

In an exemplary embodiment of the transient reducing unit, its intermediate portion of the transient reducing unit and the arcing occurrence surface extends not fully about the conducting element or the longitudinal axis but only partially. Depending on the space available and on further requirements, the shell-shaped transient reducing unit may extend about one fourth or one third of the circumference of the conducting element, for example. Other values may be applicable depending on the particularities. However, it is important that the interior volume in between the conducting element and an intermediate portion of the transient reducing unit remains above a minimal size threshold of the volume such that its function remains essentially unaffected. In this case where the transient reducing unit embraces the conducting element only partially, the gap geometry also comprises the virtual surfaces that extend laterally of the transient reducing unit in a radial direction with respect to the longitudinal axis in between the surface of the conducting element and the intermediate portion of the transient reducing unit. Again, the interior volume as well as the gap geometry form decisive parameters for defining the resonance frequency.

Regardless, whether the transient reducing unit fully embraces/surrounds the first conducting element in the circumferential direction in full or only partially, the arcing occurrence surface may be formed or may comprise at least one protrusion for defining the exact spot where arcing is triggered. The at least one radially inwardly protruding nose-like protrusion contributes to the gap geometry in that it reduces the gap distance between the arcing occurrence surface and the surface of the conducting element such that arcing will take place at exactly this spot.

If not only a single wavelength, i.e. frequency, of one particular VFT but a whole range of frequencies is to be reduced, the distance between the arcing occurrence surface and the at least one permanent electric contact portion is selectable accordingly. Depending on the embodiment of the high-voltage device, different transient reducing units may be appointed to address different ranges of VFT-frequencies.

Compared to prior art devices, the inventive high-voltage device according to various exemplary embodiments of the present disclosure does not necessarily need a resistor element, i.e. a resistor component, in order to reduce the VFTs and can therefore be provided without substantial room consumption. Hence, the transient reducing unit is substantially resistor-free. The placement of the transient reducing unit in the direct vicinity of the conducting element is understood as close enough in order to generate arcing once a VFT occurs. The term “close enough” is understood as closer or equal to 3 mm distance between the conducting element and the arcing occurrence surface in case of SF₆ gas as insulation means. Moreover, the term “direct vicinity” does not embrace a direct contact between conducting element and the transient reducing unit as this would not allow arcing to happen.

Further, the term “the transient potential difference” is to be understood as an electrical potential difference due to the existence of at least one VFT.

According to an exemplary embodiment, the high-voltage device in accordance with the present disclosure features at least one transient reducing unit comprising at least two arcing occurrence surfaces.

According to another exemplary embodiment, a method for equipping a high-voltage device with means for reducing very fast transients is provided. The high-voltage device includes a conducting element and is adapted for conducting and/or switching high currents. The method comprises positioning at least one transient reducing unit for reducing voltage peaks of existing propagating VFTs in the direct vicinity of a conducting element such that arcing is generated between the conducting element and at least one arcing occurrence surface of the at least one transient reducing unit when the potential difference between the transient reducing unit and the conducting element exceeds a threshold value. The at least one arcing occurrence surface is arranged at an opposite end of at least one permanent electric contact portion of the at least one transient reducing unit to the conducting element.

Basically, the transient reducing unit according to various exemplary embodiments of the present disclosure is arrangable at any location along the conductor bar in the direction of the longitudinal axis as long as its functionality remains substantially untouched. It may also be integrated in GIS switchgear like disconnectors or circuit breakers.

The advantages addressed in the above description relating to the high-voltage device apply likewise and/or analogously to the method as well. Thus, a lengthy reiteration thereof in terms of a description of the method is omitted. However, it is to be understood that features of exemplary embodiments as described herein with respect to a high-voltage device are applicable to the features of the exemplary method.

Further exemplary aspects, details, embodiments and advantages will be described herein with reference to the accompanying drawings.

Reference will now be made in detail to the various exemplary embodiments, one or more examples of which are illustrated in the drawings. Each example is provided by way of explanation and is not meant as a limitation. For example, features illustrated or described as part of one embodiment can be used on or in conjunction with other embodiments to yield yet a further embodiment. It is intended that the present disclosure includes such modifications and variations.

A number of embodiments will be explained below. In this case, identical structural features are identified by identical reference symbols in the drawings. The structures shown in the drawings are not depicted true to scale but rather serve only for the better understanding of the exemplary embodiments.

As used herein, high-voltage devices include high-voltage and high-power switching and/or conducting devices, switches with or without arc quenching, disconnectors, grounding devices as well as further switching devices from the field of high-voltage technology. Further, a conductor, a conducting device, or a conducting element as described herein refers generally to a high-voltage conductor that may be arranged within a housing. A conducting device can be, for example, a busbar, in particular in a switching device, or a plug contact in a busbar, etc. The conducting element is for continuously transporting current through it.

The drawings describe features of the present disclosure exemplarily in connection with exemplary embodiments of switching devices and conducting devices. More particularly, a person skilled in the art will understand that embodiments described herein can generally be applied to all apparatuses adapted for high-voltage applications. The term high-voltage device is used for enclosing both high-voltage switching devices and high-voltage conducting devices.

According to exemplary embodiments described herein, at least one transient reducing unit is provided. According to exemplary embodiments of the present disclosure, it is desired to reduce already existing propagating VFTs, i.e. to reduce them after they have already been generated. In order to do so, the transient reducing unit is positioned at a specific distance close to a conducting element. The gaps between the end of the transient reducing unit and the conducting element are sized such that sparking occurs intentionally at VFT stress.

For example, the transient reducing unit is sized and positioned according to exemplary embodiments of the present disclosure such that the transient reducing unit is adapted for arcing to happen due to the occurrence of VFT only. In other words, the transient reducing units is not supposed to conduct high current during switching. High current would, for example, be conducted if the transient reducing unit were positioned parallel to the main contact of a disconnector circuit for providing a parallel connection during switching, as described above in the background section.

According to exemplary embodiments of the present disclosure, this sparking is placed at positions, where the sparks do not harm the function of the electrical application such as the switch gear. As it is possible to provide many transient reducing units along a switching or conducting device, and as the VFTs are reflected many times at each switching operation, many sparks will occur. Each spark consumes a small portion of energy from the VFT thus reducing the peak and/or rate of rise of the VFT.

The terms “arcing” and “sparking” are used synonymously hereinafter. They embrace all kind of spark generation between two elements. Arcing may happen through air, insulating gas, or an insulating solid.

According to exemplary embodiments of the present disclosure, in order to avoid particle generation, the parts of the transient reducing units at the location where the intended sparking at VFT stress takes place may be free of coating and/or painting. In several exemplary embodiments, the spark energy is sufficiently small, so that material erosion of metal parts does not occur.

The transient reducing unit may have different geometries such as a toroid shape, different cross sections, different diameters, spiral wound shields, etc. depending on the intended sparking for a variety of VFT stress.

When VFTs propagate along the conducting element in a direction of a longitudinal axis 180 being defined by the conducting element, they generate a transient potential difference between the end of the transient reducing unit and the conducting element. If the distance between the transient reducing unit and the conductor is small, then this transient potential difference may lead to small sparks in this small gap.

According to an exemplary embodiment, a suitable distance between conducting element and the transient reducing unit is larger than about 0.2 mm. For example, the distance between the conducting element and the transient reducing unit can be larger than about 0.3 mm. According to an exemplary embodiment, the distance between the conducting element and the transient reducing can be larger than about 0.5 mm when employing SF₆ gas as the insulation means.

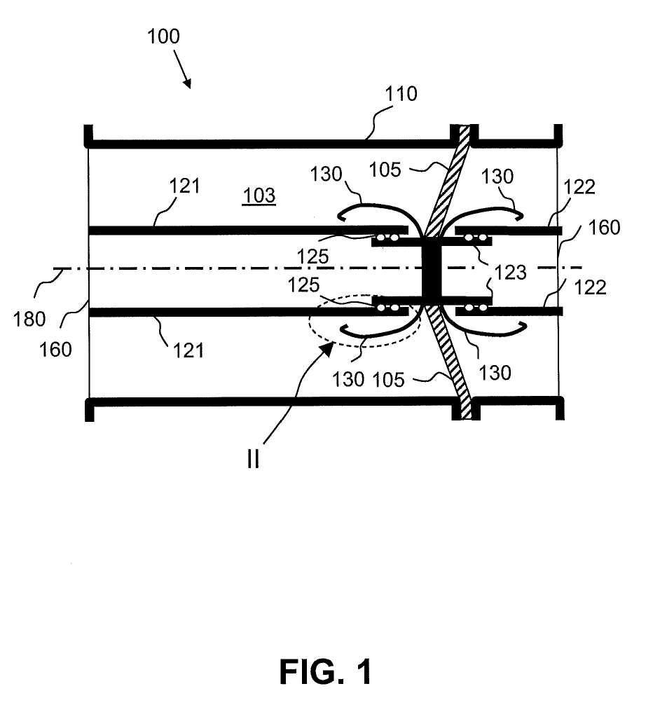

A suitable maximum distance for the gap 303 formed in between the conducting element and the transient reducing unit is about 3 mm, more particular about 2 mm, or even more particular 1 mm, these sizes typically refer to insulated devices such as by SF₆ insulation. In air insulated devices, the maximum distances will measure about 10 mm, more particular about 5 mm, or even more particular 1 mm. As to been seen in FIGS. 1 to 7, the distances referred to are measured about perpendicular to a direction of a longitudinal axis 180 defined by a housing and/or a conducting unit respectively.

The distance between the conducting element and the transient reducing unit is defined as the distance between those two parts on the conducting element and the transient reducing unit that are closest to each other. Generally, the arcing occurs between these two parts. This part on the transient reducing unit shall be called an “arcing occurrence surface” herein.

FIG. 1 illustrates a high-voltage switching device 100 according to an exemplary embodiment of the present disclosure. A section of the high voltage device 100 is illustrated in a cross-sectional view. FIG. 1 shows an exemplary plug contact in a GIS busbar according to embodiments described herein. It is to be understood that the GIS busbar could also be a cross-shaped or T-element instead of a straight connection. Generally, the busbar as shown serves for joining up individual GIS components.

According to an exemplary embodiment, the switching device 100 illustrated in FIG. 1 may be in the form of a module of a gas-insulated, encapsulated assembly. The switching device 100 has a housing 110, which may be made of metal and filled with an insulating gas 103 such as SF₆, for example. There are two main openings 160 in the exemplary switching device 100 illustrated in FIG. 1. These openings are each sealed in a gas-tight manner by a barrier insulator in a manner which is electrically insulated from the housing 110.

In the exemplary embodiment of FIG. 1, a first conducting element 121 is connected to a second conducting element 122 via a third conducting element 123 (in the embodiment of FIG. 1 the inner conductor). Plug contacts 125 may be provided. The third conducting element 123 may be fixed within the housing 110 via an insulator 105. The first conducting element 121 and the second conducting element 122 are movable in relation to each other in order to allow a compensation of heat expansion, vibrations during operation, and tolerances in the lengths of specific components.

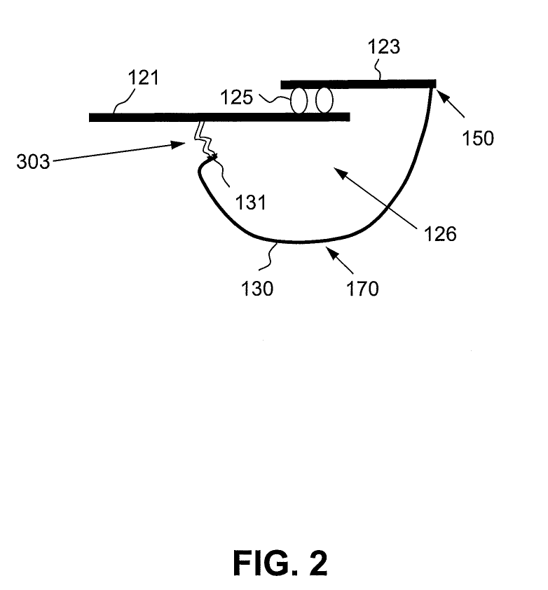

As can be seen in FIG. 1, the switching device 100 further comprises transient reducing units 130. According to an exemplary embodiment described herein, the transient reducing units 130 can be formed as bent shields. The transient reducing units 130 serve to reduce VFTs once they occur. In order to do so, the transient reducing units 130 are positioned in the direct vicinity of the conducting elements 121, 122 and 123. The transient reducing units 130 are positioned close enough to the conducting elements 121, 122 and 123 for arcing to occur at VFTs. The transient reducting units 130 may be electrically contacted by a permanent electric contact portion 150 (see, e.g., FIGS. 2-6) to the conducting element on one side in order to avoid partial discharges during normal operation.

The transient reducing units 130 may be on a high potential, and the housing 110 may be on a ground potential. Due to this arrangement, arcing between the transient reducing unit 130 and the housing 110 is to be avoided. According to exemplary embodiments described herein, the transient reducing units 130 therefore have a shape that is bent away from the closest wall of the housing 110, as is exemplarily shown in FIG. 1.

The transient reducing units 130 may be connected to a conducting element on one side, i.e. at an end portion thereof, such as the third conducting element 123 in FIG. 1. According to this arrangement, sparking in the gap will not occur during normal operation or during impulse voltage testing but only at VFT stress.

Generally, the transient reducing units 130 are on the same potential as the conducting element which the transient reducing units 130 are respectively positioned close to. That is, according to an exemplary embodiment, the transient reducing units 130 are in electrical contact with the conducting element which the transient reducing units 130 are respectively positioned close to. Nonetheless, once a VFT occurs, due to the enormous change of voltage over time (dV/dt may be up to some hundred kV per 10 ns), a potential difference exists temporarily (and locally) between the respective conducting element and the arcing occurrence surface of the transient reducing unit 130. The conducting element and the transient reducing unit 130 compensate for this difference resulting in a temporary increase of the electric field distribution and subsequent intentional arcing therebetween. Hence, although the transient reducing units 130 and the conducting elements are generally on the same potential, a potential difference may exist between them for very short times (for example, up to maximally 100 ns). This potential difference is called the transient potential difference herein.

Mechanically, the transient reducing units 130 may be mounted to the identical conducting element which the transient reducing units 130 are respectively positioned close to, or to another conducting element.

A suitable distance between the conducting element and the arcing occurrence surface of the transient reducing unit 130, in other words the gap size, depends on the specific high voltage application, the density of the insulating gas 130, the kind of insulating gas 130 (e.g. air or SF₆) and the like. However, a detailed high-frequency model of the relevant switch gear parts and calculations therewith may be used to determine suitable geometries. Thereby, suitable gap sizes and/or suitable geometries of the transient reducing units 130 may be individually or collectively determined, such as toroid shapes, bigger and smaller cross sections, different diameters, spiral shaped geometries, etc. For example, as already mentioned, the gap size may be in a range between about 0.2 mm and about 3.0 mm. According to an exemplary embodiment, the gap size may be in a range between about 1.0 mm and about 1.5 mm.

According to an exemplary embodiment of the present disclosure, that the gap between transient reducing unit 130 and the corresponding conducting element can be filled by an insulator of any kind. For example, if the switching/conducting device is embedded in insulating gas such as SF₆, the gap may consist of this gas. In other embodiments, an insulating solid is positioned between the transient reducing unit 130 and the corresponding conducting element. The solid acts both as insulator and as spacer.

The present disclosure proposes intentionally allowing arcing to occur in order to reduce the high voltage peaks. At each arcing occurrence between a transient reducing unit 130 and its corresponding conducting element, energy is consumed and absorbed. Therefore, depending on the number of transient reducing units, it is possible to damp the VFTs rather effectively.

FIG. 2 shows an enlargement of the region between the transient reducing unit 130 and the conducting element 121 as indicated by the dotted ellipse II of FIG. 1. As indicated by the two jagged arrows in FIG. 2, arcing occurs between the tip 131 of the transient reducing unit 130 and the conducting element 121. A gap 303 is laterally delimited by the arcing occurrence surface 131, i.e. its tip 131, and the conducting element 121. The shell-like transient reducing unit 130 extends in the circumferential direction about the conducting element 121.

The transient reducing unit 130 may be made of any conducting material. Advantageous results are achievable if the transient reducing unit 130 is a non-magnetic material or if does not have a high magnetic permeability (for instance, it can be a diamagnetic and/or a paramagnetic material). Exemplary materials used are, for example, aluminum, pure or in a composition, or other conductors such as copper and its compositions, i.e. copper alloys.

In the event that the transient reducing units 130 are positioned in the periphery of a disconnector itself, the reduction of VFTs is intended to happen both at closed switchgear and at open switchgear. In the open situation, this is true, of course, only for that side of the disconnector that is not at ground potential.

The transient reducing unit 130 is of shell-like shape and extends in the circumferential direction about the conducting element 121. An interior volume 126 that is confined laterally by the transient reducing unit 130 and the conductor element 121 is formed at the time of attaching the transient reducing unit 130 to the conducting element 121 in the permanent electrical contact area 150.

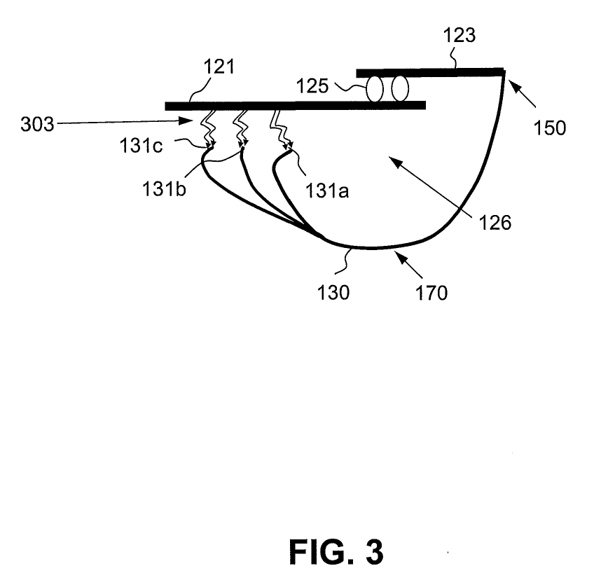

The exemplary embodiment shown in FIG. 3 differs from the exemplary embodiment as shown in FIG. 2 in that the tip end of the transient reducing unit 130, i.e. the tip end being opposite of the permanent electrical contact portion 150, features a claw-like shape when seen in the longitudinal section along the longitudinal axis 180 as it splits up into three tips each comprising an arcing occurring surface 131a, 131b and 131c, respectively. Accordingly, the exemplary embodiment illustrated in FIG. 2 features an enlarged arcing occurring surface as compared to the exemplary embodiment shown in FIG. 2.

Advantageous VFT damping results are achievable if the conducting element 121, 122, 123 defines a longitudinal axis 180, and at least one transient reducing unit 130 is shaped such that an intermediate portion 170 of the transient reducing unit 130 is positioned transverse, i.e. radial to the longitudinal axis 180, more remote than the at least one arcing occurrence surface 131, 131a, 131b, 131c. This arrangement can also be incorporated in the other embodiments addressed in the present disclosure.

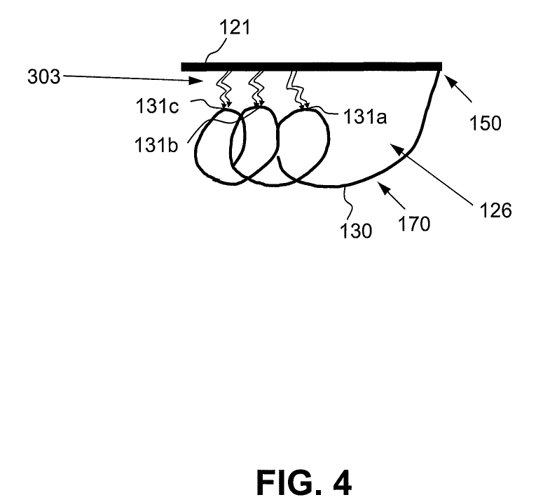

FIG. 4 shows an exemplary embodiment in which a transient reducing unit 130 is formed as a spiral. In FIG. 4, the transient reducing unit 130 comprises three arcing occurrence surfaces 131a, 131b, and 131c. Although the transient reducing unit 130 is illustrated in FIG. 4 to include three arcing occurrence surfaces 131a, 131b, and 131c, it is to be understood that a transient reducing unit 130 according to the present disclosure can include, for example, at least two, three, five or even ten arcing occurrence surfaces. Moreover, according to some embodiments, transient reducing units with even more than ten, hundred or even thousand arcing occurrence surfaces are possible.

According to exemplary embodiments of the present disclosure, at least two, five or even ten transient reducing units may be provided within a switching and/or conducting device. Thereby, a transient reducing unit is defined as each unit that allows arcing to occur at its arcing occurrence surface at VFT stress.

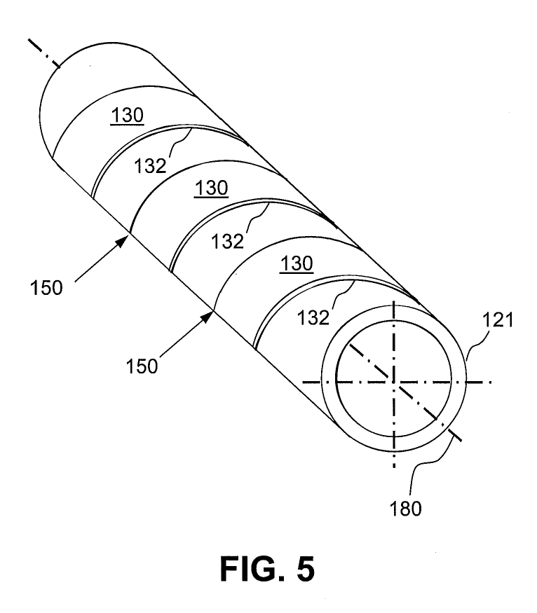

FIG. 5 shows an exemplary embodiment of a transient reducing 130 unit with a large arcing occurrence surface. The conducting unit 121 is surrounded by a wound conductor plate that acts as a transient reducing unit 130. The transient reducing unit 130 is spaced apart from the conducting unit 121 by a distance of about 0.2 mm to about 3 mm. A strip-like spacer 132 may be provided that can be made of any insulating material. According to an exemplary embodiment, the transient reducing unit 130 can be connected to the conducting element by being positioned on either end of the conducting element 121, or, alternatively, somewhere between the ends of the conducting element 121 with regard to the longitudinal axis 180 of the conducting unit 121.

According to an exemplary embodiment, the spiral wound transient reducing unit 130 may enclose the conducting element 121 in approximately a central portion of the conducting element 121, such as in the example of FIG. 5, or be arranged off-axis of the conducting element having several arcing occurrence surfaces close to the conducting element (such as in the embodiment of FIG. 4, for example).

The cross-section of the transient reducing unit 130 may be of circular or plate-like shell shape. For instance, a shell plate may be arranged partly or completely around the conducting element in a predetermined distance.

During operation, once a VFT occurs, arcing occurs between the wound plate shaped transient reducing unit 130 as illustratively shown in FIG. 5 at many positions thereby reducing the voltage peaks essentially. The transient reducing unit 130 may be connected to the same conducting unit it is arranged around.

According to other exemplary embodiments, the transient reducing unit 130 may be connected to another conducting unit. This may even enlarge the temporary potential difference at VFT stress.

The diameters of spiral shaped VFT orientate on the diameters of the respective conductor elements.

According to various embodiments described herein, the overall surface of the transient reducing unit 130 according to various embodiments described herein is, for example, more than about 10 cm² per meter conducting element. Generally, the whole high-voltage device may have an overall surface of at least one transient reducing unit of at least about 0.1 m², such as at least about 0.5 m².

The possible reduction of VFTs depends on the available total surface for arcing. Therefore, it is suitable to provide a transient reducing unit 130 with a large available total surface. The available total surface may be constituted by the surface of one transient reducing unit (as in the example of FIGS. 1, 2, and 5) extending mutually over the intermediate portion 170 of the transient reducing unit 130 when seen in the direction of the longitudinal axis 180, or may be made up of the arcing occurrence surface of several transient reducing units (as in the examples of FIGS. 3 and 4).

In more detail, with respect to conducting units, it is suitable to provide at least about 100 cm² per meter conducting unit. For example, exemplary embodiments of the present disclosure provide at least about 10 dm² per meter conducting unit and even at least about 1 m² per meter conducting unit in the longitudinal direction of the conducting unit 121.

According to exemplary embodiments of the present disclosure, at least 10% to about 50% of the conducting element is surrounded or at least partially surrounded/covered by at least one of the transient reducing units 130. Advantageously, this is achievable in that the transient reducing units can be shaped as planar shell elements such as shield-like shells, for example.

By providing transient reducing units 130 according to the present disclosure to a conducting element, it is possible to allow the reduction of VFTs in a self-regulated process. If there are no or little VFTs, there will not be any arcing so that no electric energy would be consumed. In the event of VFTs, arcing occurs. The higher the voltage of a VFT, the more arcing and thus energy consumption occurs.

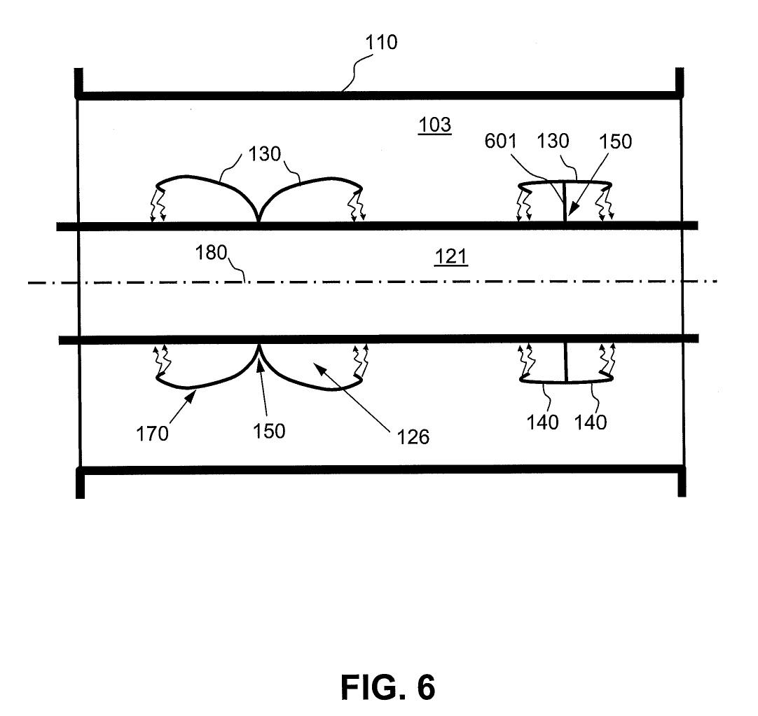

FIG. 6 is another exemplary embodiment showing the cross-sectional view of a conducting element 121 similar to FIG. 1. The conducting element is enclosed in a housing 110 that is filled with an insulating gas 103.

There are two exemplary embodiments of transient reducing units 130 shown in FIG. 6. The transient reduction unit 130 on the left hand side of FIG. 6 is similar to those shown in FIGS. 1 and 2. As can be seen, the transient reducing units 130 are mechanically and electrically contacted with the conducting element 121. Nonetheless, as explained previously, local and temporary differences in the potential result in the generation of arcings, which are depicted as jagged arrows in FIG. 6.

Another example of a transient reducing unit 130 is shown on the right hand side of FIG. 6. This transient reducing unit 130 has a T-shape when seen in a cross-section along the longitudinal axis 180 defined by the housing 110 and the conducting element 121. In comparison to the transient reducing unit 130 on the left side, the transient reducing unit 130 on the right side has only one mounting 601 to the conducting element 121. An advantage of the transient reducing unit 130 on the right side having only one common mounting 601 for two transient reducing wing portions 140 resides in a simplified and thus more economic assembly of the transient reducing unit on the conducting element 121. Expressed differently, the exemplary high-voltage device illustrated in FIG. 6 features at least one transient reducing unit 130 comprising at least two wing portions 140 that are in a permanent electric contact with the conducting element 121, 122, 123 via the common mounting 601.

The embodiment of FIG. 6 is shown in a cross-sectional view. It is to be understood that, also in other embodiments, the transient reducing unit 130 may encircle the complete, for example, circular conducting element. The arcing occurrence surface can thus be designed in the shape of a ring around the conducting element. According to other embodiments, the transient reducing unit encircles the conducting element only partly.

Since the two transient reducing units 130 shown in FIG. 6 feature different geometries which are directed to different VFTs, it becomes possible to employ such a set-up on purpose to reduce a variety of at least two different VFTs.

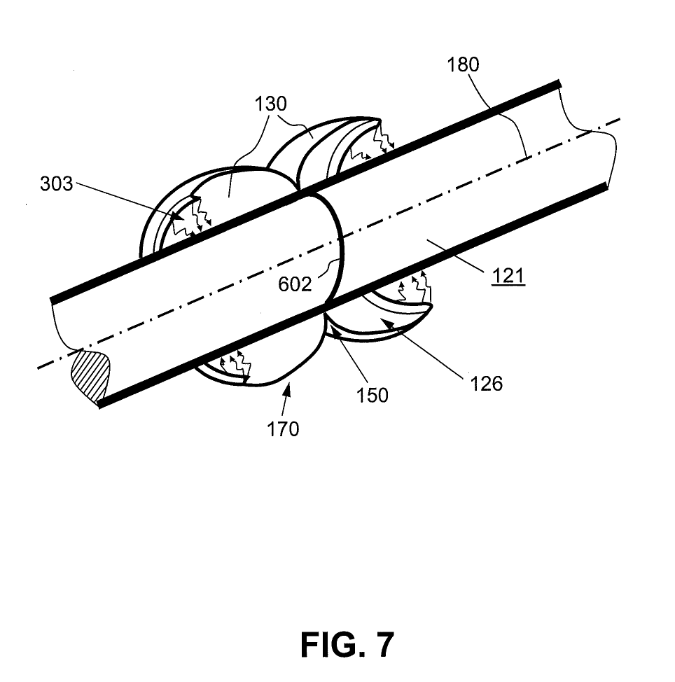

FIG. 7 shows exemplarily an open wire used in overhead lines or within a high voltage substation or switchgear. According to an exemplary embodiment, no housing is provided to embrace the conducting element as in a gas insulated substation.

As can be seen in FIG. 7, a transient reducing unit 130 is provided on the conducting element 121. The transient reducing unit 130 is fixed to the conducting element 121 with the aid of an embracing ring 602. There is only a comparatively small circumferential portion of the transient reducing unit 130 shown in FIG. 6, i.e. the portion located in a longitudinal section in the direction of the longitudinal axis 180. Between the arcing occurrence surface and the conducting element 121, air may be present through which arcing occurs at VFTs. This is exemplarily indicated with jagged arrows between the tips of the transient reducing unit 130 and the conducting element 121. For instance, the conducting element shown could be part of an air insulated switchgear (AIS). Similar to exemplary embodiments described above, the shell-like body of the transient reducing unit 130 extends fully about the bar-like conducting element 121 in the circumferential direction, but is cut partially out for better visibility of the shape and function only.

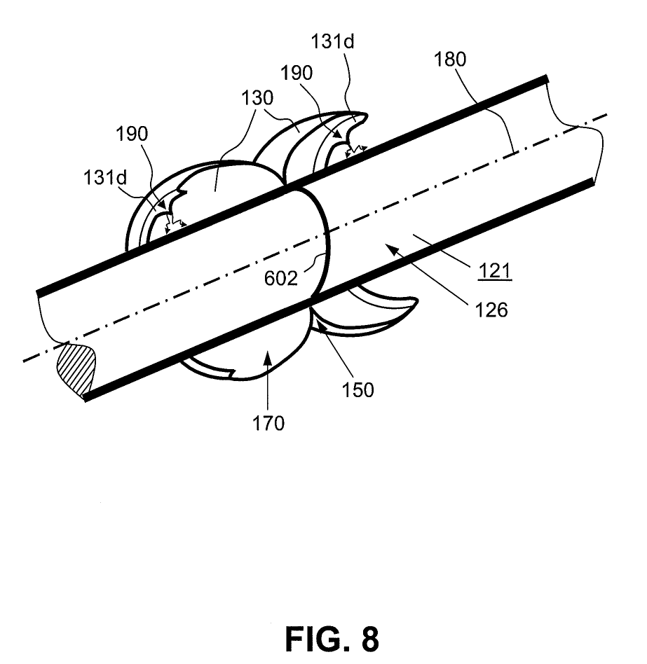

FIG. 8 shows another exemplary embodiment of the transient reducing unit 130. Since this embodiment is similar to the one shown and described with reference to FIG. 7, only the differences therebetween will be discussed hereinafter. The arcing occurrence surface 131d comprises at least one protrusion 190 for defining the exact spot where arcing is triggered. In other words, since the radially inwardly protruding nose-like protrusion 190 reduces the gap distance between the arcing occurrence surface 131d and the surface of the conducting element 121, arcing will take place at exactly this spot. Depending on the requirements, the at least one protrusion 190 can be arranged at literally any place of the arcing occurrence surface as well as the intermediate portion 170. Similar to exemplary embodiments described above, the shell-like body of the transient reducing unit 130 extends fully about the bar-like conducting element 121 in the circumferential direction, but is cut partially out for better visibility of the shape and function only.

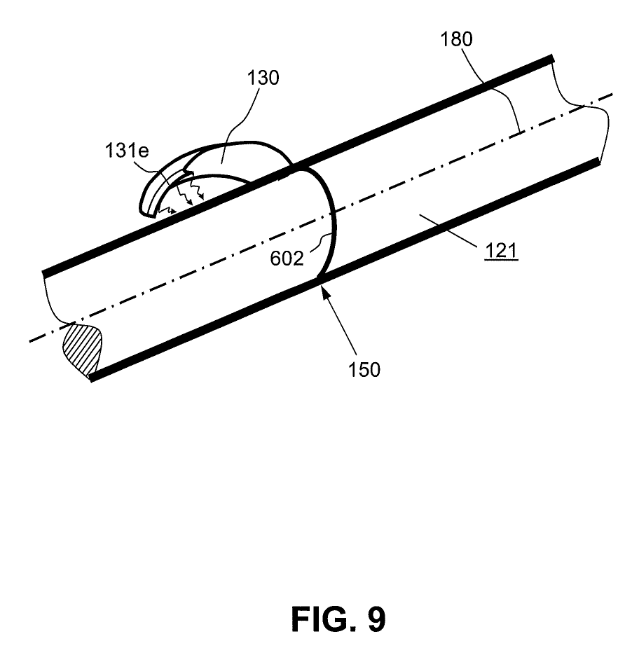

The exemplary embodiment of the transient reducing unit 130 shown in FIG. 9 differs from the transient reducing unit 130 shown in FIG. 7 in that the intermediate portion 170 of the transient reducing unit 130 is extending only partially about the conducting element 121, rather than extending fully about the conducting element 121. Thus, the intermediate portion 170 and the arcing occurrence surface 131e extend about one third about the conducting element 121 in the circumferential direction.

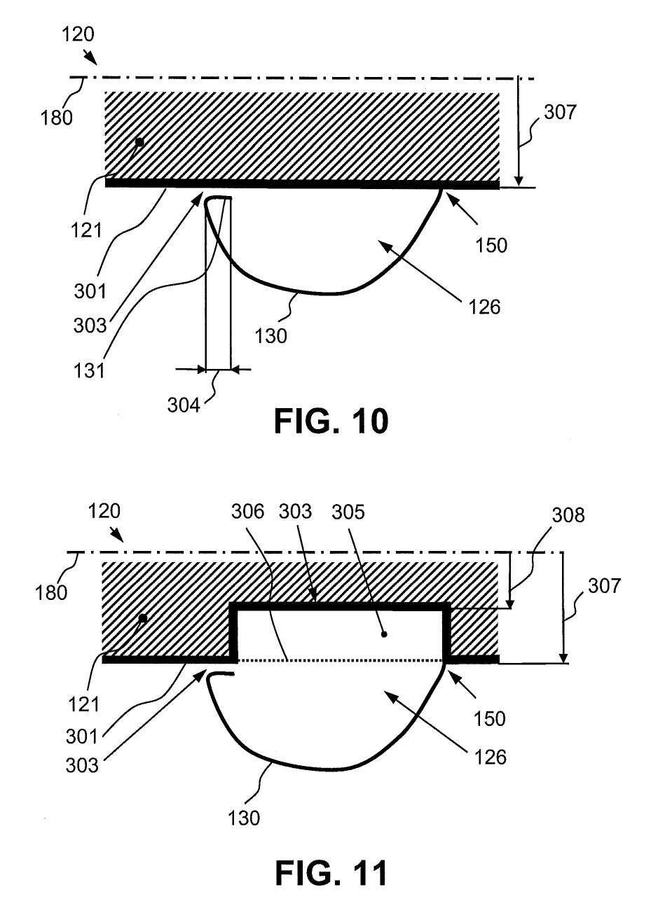

FIG. 10 illustrates another exemplary embodiment of a transient reducing unit 130. The transient reducing unit 130 shown and explained with reference to FIG. 10 differs from the one shown in FIG. 2 only in the gap geometry and in that the conducting element 121 is shown in hatched style indicating a longitudinal section of the view shown in FIG. 10. The shell-like body portion of the transient reducing unit 130 is shown as a thick line only as its thickness is thin as compared to the dimensions of the conducting element 121. In the exemplary embodiment of FIG. 10, the conducting element 121 is a conductor bar with a circular cross-section that defines the longitudinal axis 180. The conducting element 121 has an outer surface 301 along which the VFT propagates due to the skin effect. The outer surface 301 has an outer conductor dimension 307. Here, the dimension is a radius. The interior volume 126 is delimited by the outer surface 301, the intermediate portion of the transient reducing unit 130 and the gap 303. In this embodiment, the shell-like body of the transient reducing unit 130 is bent inwardly at an end opposing the permanent electric contact 150 such that it extends approximately parallel to the outer surface 301 for a gap length 304 that measures about three times the dimension of the gap distance between the arcing occurrence surface 131 and the adjacent outer surface 301 of the conductor element 121. However, a multipart-solution of the elements 170 and 131 is conceivable. The tunnel-like gap geometry contributes to a resonant voltage share of the transient potential difference by means of the increased capacitance. In this exemplary embodiment, the whole transient reducing unit 120 comprises the shell-like transient reducing unit 130 as well as a portion of the outer surface 301 of the conductor element 121.

FIG. 11 illustrates another exemplary embodiment of a transient reducing unit 130. The transient reducing unit 130 shown in FIG. 11 differs from the one shown in FIG. 10 with respect to an increased interior volume 126. The remaining elements and purposes remain the same such that previous explanations thereof apply and a repetition can be omitted. The conductor element 121 comprises a circumferential recess 300 located adjacent to the interior volume 126. Since a base dimension 308 is smaller than the outer dimension 307 of the conductor element 121, an additional partial volume 305 is formed. A dotted line 306 indicates a virtual extension of the outer surface 301 for displaying the share of the additional partial volume 305 on the increased overall interior volume 126 in comparison to the interior volume shown in FIG. 10. As compared to the embodiment shown in FIG. 10, the additional partial volume 305 contributes to an increase of the resonant voltage portion/share on the transient potential difference by means of the increased inductance. In this exemplary embodiment, the whole transient reducing unit 120 comprises both the shell-like body portion of the transient reducing unit 130 as well as the recess 300 in the conductor element 121 plus some minor portion of the outer surface 301.

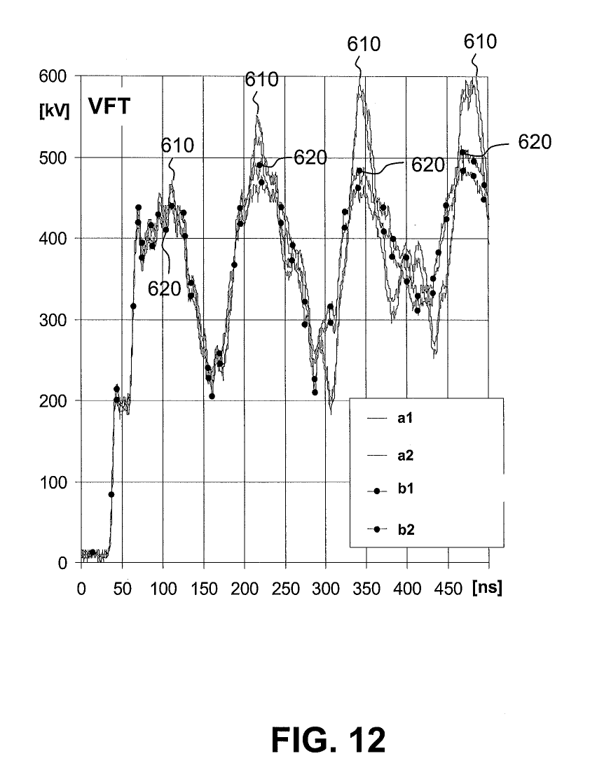

FIG. 12 exemplarily shows measuring results on a test-set up with and without VFT damping as described herein. The voltage at the high-voltage device is measured and depicted over time for a short time interval of about half a microsecond.

A VFT oscillates resulting in voltage peaks 610 in the case of no VFT damping (two instances a1 and a2 were measured). These peaks have been measured to be up to 600 kV.

The same two VFTs are generated for the test, and the resulting voltage is measured with the provision of transient reducing units as described herein in the high-voltage device. The voltage peaks for these two measured instances with VFT damping are referred to by number 620 in FIG. 12. In operation, at the occurrence of VFTs, arcing occurs at higher voltages thereby consuming energy and reducing the peak voltage. This effect becomes more and more recognizable over time. This is because, at the occurrence of the first VFT, the effect of drawing energy from the system by providing the transient reducing units and therefore allowing sparks to occur begins. At that point in time, the reduction of the peak voltage is hardly recognizable. However, after the first VFT peak, even more after two or three peaks, it is evidently recognizable in the drawings, including the graph of FIG. 12, how much the peaks could be reduced in comparison to the situation where a transient reducing unit is not provided. In the example shown in FIG. 6, the maximum VFT peak could be reduced by about 100 kV which is an essential improvement in a high voltage switching device. Thus it can be seen that the present disclosure contributes essentially to equalizing the average voltage in case of VFTs.

The present disclosure has been described with reference to exemplary embodiments which are shown in the appended drawings and from which further advantages and modifications emerge. However, the present disclosure is not restricted to the embodiments described in concrete terms, but rather can be modified and varied in a suitable manner. It lies within the scope to combine individual features and combinations of features of one embodiment with features and combinations of features of another embodiment in a suitable manner in order to arrive at further embodiments.

It will be apparent to those skilled in the art, based upon the teachings herein, that changes and modifications may be made without departing from the disclosure and its broader aspects. That is, all examples set forth herein above are intended to be exemplary and non-limiting.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A high-voltage device comprising:
a conducting element for conducting a high-voltage current; and
at least one transient reducing unit for reducing voltage peaks of existing propagating very fast transients by the generation of arcing, the at least one transient reducing unit having at least one arcing occurrence surface and at least one permanent electric contact portion being conductively connected to the conducting element,
wherein the at least one arcing occurrence surface of the at least one transient reducing unit is positioned in the vicinity of the conducting element to enable arcing to occur in a gap located between the at least one transient reducing unit and the conducting element when a transient potential difference between the at least one transient reducing unit and the conducting element is above a threshold value.

2. The high-voltage device in accordance with claim 1, wherein the at least one transient reducing unit is substantially resistor-free.

3. The high-voltage device in accordance with claim 1, wherein the at least one transient reducing unit is geometrically dimensioned to cause a change in a waveguide impedance when a very fast transient wave is propagating along the conducting element and the at least one transient reducing unit.

4. The high-voltage device in accordance with claim 1, wherein the threshold value is in a range of about 5 kV to about 100 kV.

5. The high-voltage device in accordance with claim 1, wherein the arcing occurrence surface of the at least one transient reducing unit is positioned in a distance of maximally 3 mm from the conducting element.

6. The high-voltage device in accordance with claim 1, wherein the at least one arcing occurrence surface of the at least one transient reducing unit is positioned in a gap distance of minimally 0.2 mm from the conducting element.

7. The high-voltage device in accordance with claim 1, comprising at least two transient reducing units each having at least one permanent electric contact portion, respectively,
wherein the at least one permanent electric contact portion of each corresponding one of the at least two transient reducing units is displaced from a corresponding one of the at least one arcing occurrence surface by a distance in a direction in which the conducting element, the distance being shorter than a wavelength of the VFT to be dampened.

8. The high-voltage device in accordance with claim 7, wherein the at least two transient reducing units are respectively configured to reduce a corresponding one of at least two different VFTs.

9. The high-voltage device in accordance with claim 1, wherein an overall surface of the at least one transient reducing unit is at least 0.1 m².

10. The high-voltage device in accordance with claim 1, wherein the at least one transient reducing unit is configured to at least one surround and cover the conducting element such that at least 25% of a surface of the conductor element surface is encased by the at least one transient reducing unit.

11. The high-voltage device in accordance with claim 1, further comprising at least one of a disconnector and a circuit breaker.

12. The high-voltage device in accordance with claim 1, wherein the at least one transient reducing unit is constituted by one of a non-magnetic, a diamagnetic and a paramagnetic material.

13. The high-voltage device in accordance with claim 1, wherein the conducting element defines a longitudinal axis, and
wherein the at least one transient reducing unit is shaped such that an intermediate portion of the at least one transient reducing unit is positioned transversely to the longitudinal axis more remotely than the at least one arcing occurrence surface.

14. The high-voltage device in accordance with claim 13, wherein the at least one arcing occurrence surface of the at least one transient reducing unit is positioned in a gap from the conducting element
wherein the gap has a capacitor-like gap geometry with a gap length extending in the direction of the longitudinal axis,
wherein the gap length measures at least as much as a gap distance respectively in between the at least one arcing occurrence surface and the conducting element.

15. The high-voltage device in accordance with claim 1, wherein the at least one transient reducing unit has a shell-shaped body portion,
wherein the conducting element and the shell-shaped body portion of the transient reducing unit delimit an interior volume, and
wherein the conducting element has a recess located adjacent to the interior volume.

16. The high-voltage device in accordance with claim 1, wherein the at least one arcing occurrence surface comprises at least one radially inwardly directed protrusion for locally triggering electric arcing.

17. A method for enabling a high-voltage device to reduce very fast transients, the high-voltage device having a conducting element and being adapted for at least one of conducting and switching high currents, the method comprising:
positioning at least one transient reducing unit for reducing voltage peaks of existing propagating very fast transients in a direct vicinity of a conducting element to generate arcing between the conducting element and at least one arcing occurrence surface of the at least one transient reducing unit when a transient potential difference between the at least one transient reducing unit and the conducting element is above a threshold value,
wherein the at least one arcing occurrence surface is arranged at an opposite end of at least one permanent electric contact portion of the at least one transient reducing unit that is conductively connected to the conducting element.

18. The high-voltage device in accordance with claim 2, wherein the at least one transient reducing unit is geometrically dimensioned to cause a change in a waveguide impedance when a very fast transient wave is propagating along the conducting element and the at least one transient reducing unit.

19. The high-voltage device in accordance with claim 1, wherein the threshold value is in a range of about 10 kV to about 80 kV.

20. The high-voltage device in accordance with claim 1, wherein the arcing occurrence surface of the at least one transient reducing unit is positioned in a distance of maximally 2 mm from the conducting element.

21. The high-voltage device in accordance with claim 1, wherein the at least one arcing occurrence surface of the at least one transient reducing unit is positioned in a gap distance of minimally 0.5 mm from the conducting element.

22. The high-voltage device in accordance with claim 5, comprising at least two transient reducing units each having at least one permanent electric contact portion, respectively,
wherein the at least one permanent electric contact portion of each corresponding one of the at least two transient reducing units is displaced from a corresponding one of the at least one arcing occurrence surface by a distance in a direction in which the conducting element, the distance being shorter than a wavelength of the VFT to be dampened.

23. The high-voltage device in accordance with claim 1, wherein an overall surface of the at least one transient reducing unit is at least 0.5 m².

24. The high-voltage device in accordance with claim 1, wherein the at least one transient reducing unit is configured to at least one surround and cover the conducting element such that at least 50% of a surface of the conductor element surface is encased by the at least one transient reducing unit.

25. The high-voltage device in accordance with claim 14, wherein the gap distance is minimally 0.2 mm from the conducting element.
